(19) United States
(12) Patent Application Publication
(10) Pub. No.: US 2026/0277838 A1
(43) Pub. Date: Sep. 17, 2026

(54) Die-to-die interconnect repair

(71) Applicant: Marvell Asia Pte Ltd, Singapore (SG)

(72) Inventors: Kazin Simon Blacklow, Burlington, VT (US); John Edward Gregory, JR., Dummerston, VT (US); Zachary Baldwin, Burlington, VT (US); Ting Zheng, San Jose, CA (US); Aatreya Chakravarti, Winooski, VT (US); Carlos Macian Ruiz, Los Gatos, CA (US); Samer Akiki, Redwood City, CA (US); Joshua F. Dillon, Stowe, VT (US); Mark William Kuemerle, Essex Junction, VT (US); Wolfgang Sauter, Starksboro, VT (US); Sidney William Allman, Stittsville (CA)

(21) Appl. No.: 19/562,875

(22) Filed: Mar. 11, 2026

Related U.S. Application Data
(60) Provisional application No. 63/770,922, filed on Mar. 12, 2025.

(51) Int. Cl. G06F 13/364

(52) U.S. Cl. CPC G06F 13/364

(57) ABSTRACT

A physical-layer interface (PHY) between a first die and a second die, the PHY includes: (a) a plurality of lanes configured to transfer signals between the first die and the second die and (b) a processor, which is configured to: (i) detect a non-functional lane among the plurality of lanes, and (ii) adjust one or more electrical parameters of one or more functional lanes among the plurality of lanes to compensate for bandwidth loss caused by the non-functional lane.

### CROSS-REFERENCE TO RELATED APPLICATIONS

This application claims the benefit of U.S. Provisional Patent Application 63/770,922, filed Mar. 12, 2025, whose disclosure is incorporated herein by reference.

### FIELD OF THE DISCLOSURE

The present invention relates generally to semiconductor die-to-die interconnects, and more particularly but not exclusively to repair and bandwidth management of die-to-die physical layer interfaces.

### BACKGROUND

Modern semiconductor systems increasingly rely on multi-die architectures where multiple semiconductor dies are assembled together on interposers or within advanced packaging solutions. These architectures enable the integration of heterogeneous components, such as logic dies, memory dies, and input/output dies, into a single module to achieve performance levels that would be difficult or impractical to attain with monolithic designs.

Die-to-die (D2D) interconnects serve as the communication pathways between dies in such multi-die systems. These interconnects typically comprise numerous parallel lanes that collectively provide the bandwidth required for high-speed data transfer between dies. As bandwidth requirements continue to grow, particularly in applications such as artificial intelligence accelerators, high-performance computing systems, and data center switches, the number of D2D lanes in a given system has increased substantially. Contemporary systems may employ thousands of individual D2D lanes to achieve the aggregate bandwidth demanded by modern workloads.

The physical layer (PHY) interfaces that implement D2D communication are subject to manufacturing variations and assembly-related defects. When dies are assembled together on an interposer or within a package, the connections between dies must be formed with high precision. Any defect in these connections, whether arising from the silicon fabrication process, the packaging assembly process, or other sources, can result in one or more non-functional lanes within the D2D interface.

Various approaches exist for managing lane failures in D2D interfaces. One approach involves incorporating redundant spare lanes that can be substituted for failed lanes. For example, certain interface specifications prescribe adding one or more spare lanes to each group of data lanes, allowing failed lanes to be swapped with functional spares. However, this approach introduces area overhead proportional to the number of tolerable failures, as the spare lanes and their associated circuitry consume silicon area and package resources regardless of whether they are ultimately needed. Another approach involves graceful degradation, where the system continues to operate with reduced bandwidth when lanes fail. This approach avoids the area overhead of dedicated spare lanes but introduces complexity in managing variable bandwidth at the system level.

The description above is presented as a general overview of related art in this field and should not be construed as an admission that any of the information it contains constitutes prior art against the present patent application.

### SUMMARY

An embodiment that is described herein provides a physical-layer interface (PHY) between a first die and a second die, the PHY includes: (a) a plurality of lanes configured to transfer signals between the first die and the second die and (b) a processor, which is configured to: (i) detect a non-functional lane among the plurality of lanes, and (ii) adjust one or more electrical parameters of one or more functional lanes among the plurality of lanes to compensate for bandwidth loss caused by the non-functional lane.

In some embodiments, the one or more electrical parameters include an operating frequency and an operating voltage, and the processor includes a dynamic voltage and frequency scaling (DVFS) block, which is configured to adjust at least one of the operating frequency and the operating voltage of the one or more functional lanes. In other embodiments, the processor includes a die-to-die test block, which is configured to test the plurality of lanes and detect the non-functional lane. In yet other embodiments, the processor is configured to determine whether a target bandwidth is achieved in response to adjusting at least one of the operating frequency and the operating voltage.

In some embodiments, the processor is configured to further adjust at least one of the operating frequency and the operating voltage to achieve the target bandwidth at a reduced operating voltage. In other embodiments, in response to not achieving the target bandwidth, the processor is configured to negotiate a revised bandwidth less than the target bandwidth based on the (i) non-functional lane, and (ii) adjusted at least one of the operating frequency and the operating voltage of the one or more functional lanes. In yet other embodiments, in response to adjusting the one or more electrical parameters, the processor is configured to detect an additional non-functional lane among the one or more functional lanes.

In some embodiments, in response to detecting the additional non-functional lane, the processor is configured to iteratively adjust the one or more electrical parameters of one or more remaining functional lanes to compensate for bandwidth loss caused by the non-functional lane and the additional non-functional lane. In other embodiments, in response to adjusting the one or more electrical parameters, the processor is configured to redetermine the functionality of the detected non-functional lane. In yet other embodiments, the processor includes an interface configured to present a consistent bandwidth between the first die and the second die regardless of the non-functional lane.

There is additionally provided, in accordance with an embodiment that is described herein, a method for compensating for bandwidth loss in a physical-layer interface (PHY) between a first die and a second die, the method including during a setup phase, testing a plurality of lanes configured to transfer signals between the first die and the second die. A non-functional lane is detected among the plurality of lanes. One or more electrical parameters of one or more functional lanes among the plurality of lanes are adjusted to compensate for bandwidth loss caused by the non-functional lane.

In some embodiments, the one or more electrical parameters include an operating frequency and an operating voltage. In other embodiments, adjusting the one or more electrical parameters includes increasing at least one of the operating frequency and the operating voltage of the one or more functional lanes. In yet other embodiments, the method further includes determining whether a target bandwidth is achieved in response to adjusting the one or more electrical parameters.

In some embodiments, in response to not achieving the target bandwidth, iteratively adjusting the one or more electrical parameters until the target bandwidth is achieved or a maximum operating frequency is reached. In other embodiments, the method further includes: (a) testing the plurality of lanes at a plurality of combinations of operating frequencies and operating voltages, (b) recording, for each combination, a bandwidth based on a number of functional lanes at the combination, (c) storing the combination of operating frequency and operating voltage that obtained a maximum bandwidth, and (d) operating the PHY at the stored combination during a mission mode following the setup phase. In yet other embodiments, testing the plurality of lanes at the plurality of combinations includes sweeping from a base operating frequency to a maximum operating frequency and from a base operating voltage to a maximum operating voltage.

In some embodiments, the method further includes, in response to adjusting the one or more electrical parameters, detecting an additional non-functional lane among the one or more functional lanes, and iteratively adjusting the one or more electrical parameters of one or more remaining functional lanes to compensate for bandwidth loss caused by the non-functional lane and the additional non-functional lane. In other embodiments, the method further includes, in response to adjusting the one or more electrical parameters, redetermining the functionality of the detected non-functional lane. In yet other embodiments, the setup phase includes at least one of a boot sequence and a link training phase.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an electronic device comprising a multi-die system with die-to-die interconnects, in accordance with an embodiment that is described herein;

FIG. 2 is a flow chart that schematically illustrates a method for compensating for bandwidth loss in the electronic device of FIG. 1 by compensating for bandwidth loss in physical-layer interfaces (PHYs) in the die-to-die interconnects, in accordance with an embodiment that is described herein;

FIGS. 3A, 3B, and 3C are block diagrams that schematically illustrate various operating conditions applied based on the method for improving communication bandwidth of FIG. 2, in accordance with embodiments that are described herein;

FIG. 4 is a flow chart that schematically illustrates a method for compensating for bandwidth loss in the electronic device of FIG. 1 by obtaining a maximum bandwidth in the die-to-die interconnect, in accordance with an embodiment that is described herein;

FIGS. 5A, 5B, 5C, and 5D are block diagrams that schematically illustrate various operating conditions applied based on the method for improving communication bandwidth of FIG. 4, in accordance with embodiments that are described herein;

FIG. 6 is a flow chart that schematically illustrates a method for compensating for bandwidth loss in the electronic device of FIG. 1 by obtaining maximum bandwidth at reduced power consumption, in accordance with an embodiment that is described herein; and

FIGS. 7A-7D are block diagrams that schematically illustrate various operating conditions applied based on the method for compensating for bandwidth loss of FIG. 6, in accordance with embodiments that are described herein.

### DETAILED DESCRIPTION OF EMBODIMENTS OVERVIEW

Multi-die semiconductor systems employ die-to-die (D2D) interconnects comprising numerous parallel lanes to achieve the bandwidth required for applications such as artificial intelligence accelerators and high-performance computing systems. These systems may comprise thousands of D2D lanes, and a failure in even a single lane can result in the loss of an entire assembled module, including expensive components such as but not limited to Application-Specific Integrated Circuit (ASIC) dies, processing units, high-bandwidth memory (HBM) dies, interposers, and advanced-node chiplets. Yield loss at final test is particularly costly because the D2D interfaces cannot be fully tested until the module assembly is complete.

Conventional approaches to managing lane failures include redundancy schemes and graceful degradation. Redundancy schemes incorporate spare lanes that can be substituted for failed lanes, but this approach introduces area overhead proportional to the number of tolerable failures, consuming silicon area and package resources regardless of whether the spare lanes are ultimately needed. Graceful degradation allows the system to continue operating with reduced bandwidth when lanes fail, but this approach introduces complexity in managing variable bandwidth at the system level and may not meet customer expectations for consistent interface behavior.

Embodiments of the present disclosure that are described herein address these challenges by providing a physical-layer interface (PHY) configured to compensate for bandwidth loss caused by non-functional lanes by adjusting electrical parameters of the remaining functional lanes. In some embodiments, the PHY comprises a processor configured to detect non-functional lanes and adjust electrical parameters of the functional lanes. In some embodiments, the processor comprises a dynamic voltage and frequency scaling (DVFS) block configured to adjust the operating frequency and operating voltage of the functional lanes to increase their data transfer rate, thereby compensating for the bandwidth that would otherwise be lost due to the non-functional lane. In some embodiments, the processor comprises a die-to-die test block configured to test the lanes and detect non-functional lanes during a setup phase, such as a boot sequence or link training phase.

In other embodiments, at least one of the dynamic voltage and frequency scaling (DVFS) block, the die-to-die test block, and the interface may be implemented separately from the processor or distributed across multiple components within the PHY.

In some embodiments, the PHY is configured to (i) test the lanes at a plurality of combinations of electrical parameters, such as but not limited to operating frequencies and operating voltages, (ii) record the bandwidth achieved at each combination based on the number of functional lanes, (iii) store the combination that obtained a maximum bandwidth, and (iv) operate at the stored combination during a mission mode following the setup phase. In some embodiments, the PHY configured to present a consistent bandwidth to the rest of the die regardless of the non-functional lanes, providing an interface that is straightforward to integrate without requiring the system to manage variable bandwidth.

The disclosed embodiments advantageously provide lane repair for D2D interfaces without the area overhead of dedicated spare lanes. The same circuitry used for bandwidth compensation may also be used to maximize bandwidth or minimize power consumption, effectively providing multiple uses for the same hardware. The disclosed approach enables D2D interfaces to recover from lane failures without loss of performance or impact to the chip's functionality, while presenting a consistent interface to the rest of the system.

### Definitions

In the present context, the term “physical-layer interface” or “PHY” may refer to circuitry that implements the physical connection and signal transfer between two semiconductor dies. For example, a PHY may comprise transmit lanes, receive lanes, and associated control circuitry for transferring data between a first die and a second die assembled on an interposer or in any other suitable packaging configuration. The PHY may be implemented (i) within the first and second dies, for example, when the dies are vertically stacked, and/or (ii) within a substrate, such as the interposer coupled to the first and second dies.

In the present context, the term “lane” may refer to a signal path configured to transfer data between two dies. For example, a lane may comprise a transmit conductor on a first die, a corresponding receive conductor on a second die, and the interconnect therebetween. Typically, each die comprises both transmit conductors and receive conductors.

In the present context, the term “non-functional lane” may refer to a lane that is unable to reliably transfer data at a given operating condition. For example, a non-functional lane may be a lane that has failed due to a manufacturing defect, or a lane that becomes non-functional at an elevated operating frequency and/or not suitable power due to marginal performance characteristics.

In the present context, the term “functional lane” may refer to a lane that is able to reliably transfer data at a given operating condition. For example, a functional lane may be a lane that passes testing at a specified operating frequency and operating voltage.

In the present context, the term “operating frequency” may refer to the data transfer rate at which a lane or group of lanes operates. For example, an operating frequency may be specified in gigahertz (GHz) and may determine the number of data transfers per second on each lane. Based on this example, the data transfer may be specified in gigatransfers per second (GT/s).

In the present context, the term “operating voltage” may refer to the supply voltage provided to the circuitry of a lane or group of lanes. For example, an operating voltage may be specified in volts and may affect the speed and power consumption of the lane at specified electrical currents.

In the present context, the term “dynamic voltage and frequency scaling” or “DVFS” may refer to a technique for adjusting the operating voltage and operating frequency of circuitry to achieve desired performance or power characteristics. For example, a DVFS block may increase the operating frequency of functional lanes to compensate for bandwidth loss caused by a non-functional lane.

In the present context, the term “target bandwidth” may refer to a specified data transfer capacity that the PHY is configured to achieve. For example, a target bandwidth may be 80 giga transfers per second for a PHY with eight lanes operating at 10 gigahertz each.

In the present context, the term “maximum bandwidth” may refer to the highest data transfer capacity achievable by the PHY across a range of operating conditions. For example, the maximum bandwidth may be achieved at an operating frequency where the product of the number of functional lanes and the operating frequency is maximized.

In the present context, the term “setup phase” may refer to a period during which the PHY is configured and tested prior to normal operation. For example, a setup phase may occur during a boot sequence or link training phase when the system initializes. Additionally, or alternatively, the setup phase may refer to troubleshooting and maintenance operations while the system is operating in the field (e.g., in a mission mode defined herein).

In the present context, the term “mission mode” may refer to the normal operating state of the PHY following the setup phase. For example, during mission mode, the PHY operates at the stored combination of operating frequency and operating voltage to transfer data between dies.

In the present context, the term “die-to-die test block” may refer to circuitry configured to test the lanes of a PHY and identify functional and non-functional lanes. For example, a die-to-die test block may test each lane at various operating conditions and report the results to a DVFS block for adjustment of electrical parameters.

In the present context, the term “processor” may refer to circuitry within the PHY that is configured to control the operation of the lanes and manage bandwidth compensation. The term “processor” is a generic name for any suitable type of processing circuitry, such as a general-purpose processor, a microcontroller, a digital signal processor (DSP), an application-specific integrated circuit (ASIC), a field-programmable gate array (FPGA), a Central Processing Unit (CPU), a Graphics Processing Unit (GPU), a Tensor Processing Unit (TPU), or any combination thereof. For example, a processor may comprise at least one of a dynamic voltage and frequency scaling (DVFS) block, a die-to-die test block, and an interface to the die core. The processor may be configured to detect non-functional lanes, adjust electrical parameters of functional lanes, and present a consistent bandwidth to the rest of the die.

In the present context, the term “interface” may refer to circuitry within the processor that is configured to present a consistent bandwidth between the first die and the second die regardless of non-functional lanes. For example, the interface may communicate with die core blocks to provide data transfer capabilities without requiring the die core to manage variable bandwidth caused by lane failures.

In the present context, the term “repair” may refer to the process of compensating for a failed component by adjusting electrical parameters of remaining functional components to maintain system operation. For example, repair of a failed data lane of a PHY may involve adjusting data transmission across remaining functional data lanes of the PHY to maintain the required aggregate bandwidth.

The description above is presented as a general overview of embodiments of the present disclosure, which are described in detail herein.

### System Description

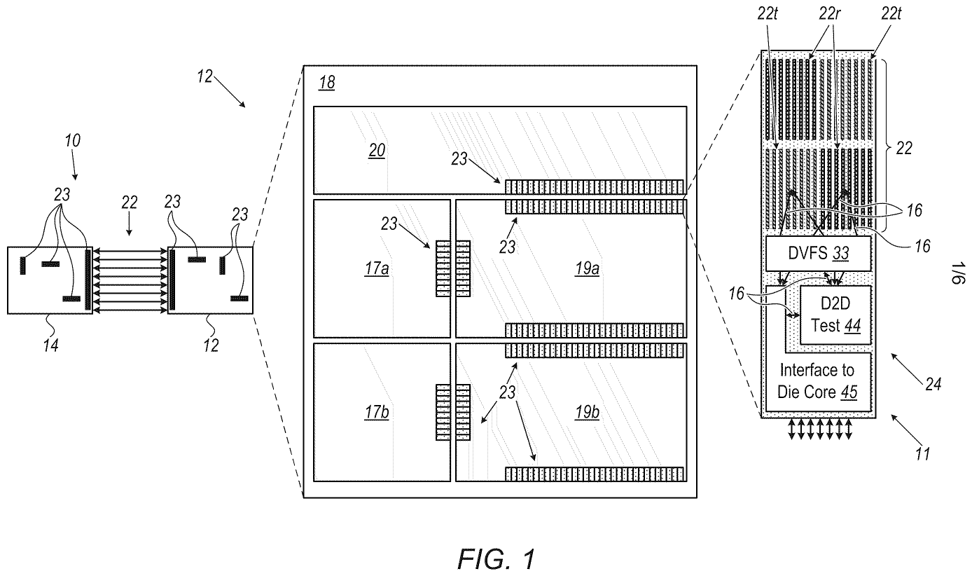

FIG. 1 is a block diagram that schematically illustrates an electronic device 10 comprising a multi-die system with die-to-die interconnects, in accordance with an embodiment that is described herein. In some embodiments, electronic device 10 comprises multiple semiconductor dies, such as a first die 12 and a second die 14 assembled on an interposer 18 and communicate via die-to-die interconnects described below. In the present example, interposer 18 serves as a substrate upon which dies 12 and 14 are mounted and through which signals 16 are exchanged between the dies.

Reference is now made to first die 12, which comprises an input/output (IO) block 20, memory blocks 17a and 17b provide storage capacity, and die core blocks 19a and 19b contain processing logic. IO block 20 provides external input/output connectivity for first die 12. At least one of, and typically both, dies 12 and 14 comprise multiple physical-layer interface (PHY) blocks 23 distributed between the blocks described above, as well as along the periphery to facilitate communication of signal 16 between dies 12 and 14 as well as between blocks within at least one of dies 12 and 14.

Reference is now made to an inset 11 showing an expanded view one PHY block 23 with the internal components that enable the die-to-die communication and bandwidth compensation functionality. In some embodiments, PHY block 23 comprises multiple lanes 22, and a processor 24. The die-to-die communication is accomplished through lanes 22 that comprise transmit (TX) lanes 22t for transmitting data and receive (RX) lanes 22r for receiving data. Each PHY block 23 contains multiple lanes 22, for example sixteen lanes as shown in the expanded view of inset 11. Signals 16 are exchanged via PHY block 23 between the blocks of first die 12 and between dies 12 and 14. In some embodiments, PHY blocks 23 may be implemented (i) within at least one of and typically within both dies 12 and 14, for example, when the dies are vertically stacked, and/or (ii) within a substrate, such as the interposer 18 coupled to dies 12 and 14.

In some embodiments, PHY block 23 comprises a processor 24 configured to detect one or more non-functional lanes 22 and to adjust electrical parameters of functional lanes among lanes 22. Processor 24 comprises a dynamic voltage and frequency scaling (DVFS) block 33 configured to provide dynamic voltage and frequency scaling capability, allowing adjustment of the operating voltage and operating frequency of lanes 22. Processor 24 further comprises a die-to-die test block 44 configured to enable testing of the die-to-die links to determine bandwidth (BW) of the communication. The BW may be determined (i) for each PHY block 23, (ii) between blocks of die 12, and (iii) the total BW between dies 12 and 14. Processor 24 is further configured to identify functional and non-functional lanes among lanes 22.

In some embodiments, processor 24 comprises an interface 45 configured to provide connection between PHY block 23 and die core blocks 19a and 19b, presenting a consistent bandwidth to the rest of the die regardless of the internal operating conditions of lanes 22. TX lanes 22t, and RX lanes 22r are shown as parallel conductors within PHY block 23, with signals 16 flowing through these lanes to accomplish data transfer through lanes 22. In the present example, signals 16 are exchanged via PHY block 23 between first die 12 and second die 14.

In some embodiments, die-to-die test block 44 of processor 24 is configured to test lanes 22 during a setup phase, such as a boot sequence or link training phase, and to detect non-functional lanes among lanes 22. Upon detecting a non-functional lane 22, DVFS block 33 of processor 24 is configured to adjust electrical parameters of the functional lanes 22, to compensate for bandwidth loss caused by the one or more non-functional lanes 22. In the present example, DVFS block 33 is configured to provide dynamic voltage and frequency scaling capability, allowing adjustment of the operating voltage and operating frequency of the functional lanes 22.

In some embodiments, by adjusting (e.g., increasing) at least one of the operating frequency and the operating voltage of the functional lanes, processor 24 is configured to increase the data transfer rate of the functional lanes 22 to maintain the target bandwidth despite the presence of the one or more non-functional lanes 22. In such embodiments, interface 45 is configured to provide the connection between PHY blocks 23 and die core blocks 19a and 19b, presenting a consistent bandwidth to the rest of the die regardless of the internal operating conditions of lanes 22. This configuration allows die core blocks 19a and 19b to interact with PHY block 23 without requiring the die core to manage variable bandwidth, thereby providing an interface that is straightforward.

This particular configuration of electronic device 10, die 12 and PHY block 23 is shown by way of example, in order to illustrate certain problems that are addressed by embodiments of the present invention and to demonstrate the application of these embodiments in enhancing the performance of such an electronic device. Embodiments of the present invention, however, are by no means limited to this specific sort of example electronic device, dies and PHY blocks, and the principles described herein may similarly be applied to other sorts of electronic devices and die-to-die communications.

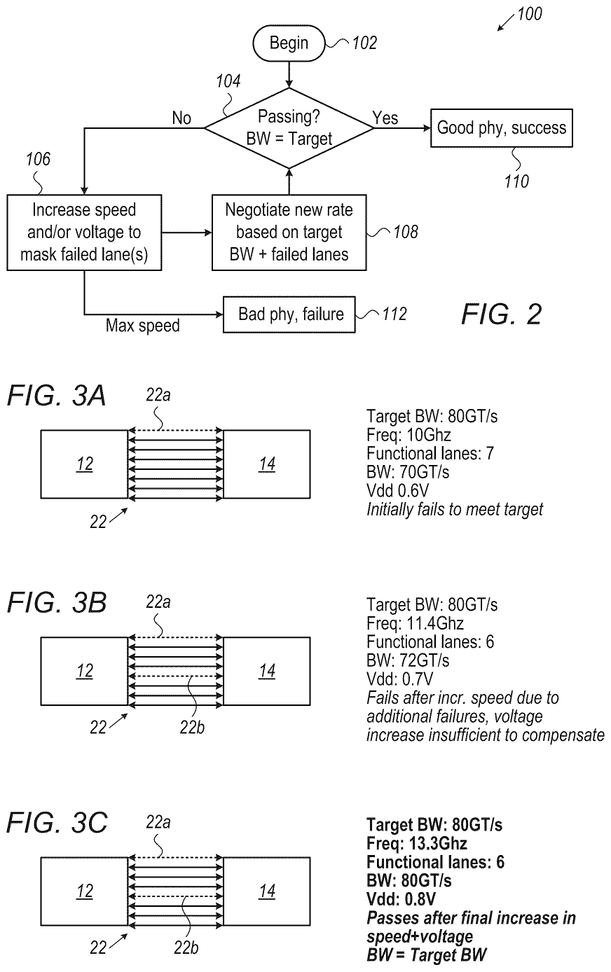

FIG. 2 is a flow chart that schematically illustrates a method 100 for compensating for bandwidth loss in electronic device 10 by compensating for bandwidth loss in physical-layer interfaces (PHYs) in the die-to-die interconnects, in accordance with an embodiment that is described herein. In some embodiments, method 100 is performed by processor 24 within PHY block 23 during a setup phase.

At a start testing step 102, processor 24 initiates the bandwidth compensation process. Die-to-die test block 44 tests lanes 22 at an initial operating frequency and operating voltage to determine whether the current bandwidth equals the target bandwidth.

At a decision step 104, processor 24 determines whether the current bandwidth equals the target bandwidth specified for the die-to-die connectivity in electronic device 10. If the bandwidth reached the target (“Yes” branch), method 100 proceeds to a PHY qualification step 110, indicating a good PHY block 23 and successful bandwidth compensation. If the bandwidth does not equal the target (“No” branch), method 100 proceeds to a bandwidth increasing step 106.

At bandwidth increasing step 106, DVFS block 33 increases the operating frequency and/or operating voltage to compensate for the one or more non-functional lanes 22. By increasing the data transfer rate of the functional lanes 22, processor 24 compensates for the bandwidth that would otherwise be lost due to the non-functional lanes, as described in detail in FIG. 1 above.

At a negotiation step 108, processor 24 negotiates a new rate based on the target bandwidth and the failed lanes. The negotiation occurs between PHY block 23 on first die 12 and the corresponding PHY on second die 14 to establish a shared operating frequency and operating voltage.

After negotiation step 108, method 100 loops back to decision step 104 to re-evaluate whether the achieve bandwidth now equals the target bandwidth. This loop continues until either the target bandwidth is achieved or the maximum operating frequency of PHY block 23 is reached. If the maximum operating frequency is reached without achieving the target bandwidth, method 100 proceeds from bandwidth increasing step 106 to a PHY disqualification step 112, indicating a bad PHY block 23 and failure of the bandwidth compensation process.

In response to adjusting the electrical parameters at bandwidth increasing step 106, processor 24 detects whether an additional non-functional lane has emerged among the previously functional lanes. Some lanes 22 that were functional at a lower operating frequency may become non-functional at an elevated operating frequency due to marginal performance characteristics. In response to detecting the additional non-functional lane 22, processor 24 iteratively adjusts the electrical parameters of the remaining functional lanes 22 to compensate for bandwidth loss caused by both the initial non-functional lane and the additional non-functional lane.

Additionally, in response to adjusting the electrical parameters, processor 24 redetermines the functionality of the detected non-functional lane 22. Some lanes 22 that were non-functional at a lower operating voltage may become functional at an elevated operating voltage. This allows processor 24 to recover lanes 22 that were initially classified as non-functional.

FIGS. 3A, 3B, and 3C are block diagrams that schematically illustrate examples of various operating conditions applied based on method 100 for compensating for bandwidth loss of FIG. 2, in accordance with embodiments that are described herein. The figures show first die 12 connected to second die 14 through lanes 22.

In FIG. 3A, first die 12 and second die 14 are connected by lanes 22, with a non-functional lane 22a. PHY block 23 has a target bandwidth of 80 giga transfer per second (GT/s), operates at a frequency of 10 GHz with seven functional lanes, resulting in an actual bandwidth of 70 GT/s at a supply voltage of 0.6V. This configuration initially fails to meet the target bandwidth of 80 GT/s. In the drawings of the present disclosure, the non-functional lanes are shown as broken lines in FIGS. 3A-3C, 5B-5D, and 7B-7D, and the functional lanes are shown as solid lines in FIGS. 1, 3A-3C, 5A-5D, and 7A-7C.

In FIG. 3B, DVFS block 33 increased the operating frequency to 11.4 GHz and raised the supply voltage from 0.6V to 0.7V in an attempt to compensate for the failure of lane 22a. However, a second non-functional lane 22b has failed due to the increased speed, leaving only six functional lanes 22. The resulting bandwidth is 72 GT/s, which still fails to meet the target of 80 GT/s. The voltage increase was insufficient to compensate for the additional failures caused by the increased speed.

In FIG. 3C, DVFS block 33 has further increased the operating frequency to 13.3 GHz and the supply voltage to 0.8V. With six functional lanes operating at the higher frequency, PHY block 23 achieves a bandwidth of 80 GT/s, which equals the target bandwidth. Non-functional lanes 22a and 22b remain non-functional, but the increased frequency, also referred to herein as increased speed, and increased voltage of the remaining functional lanes 22 compensates for their loss. This configuration passes after the final increase in frequency and voltage, demonstrating how dynamic voltage and frequency scaling compensates for bandwidth loss in die-to-die interconnects without requiring dedicated spare lanes.

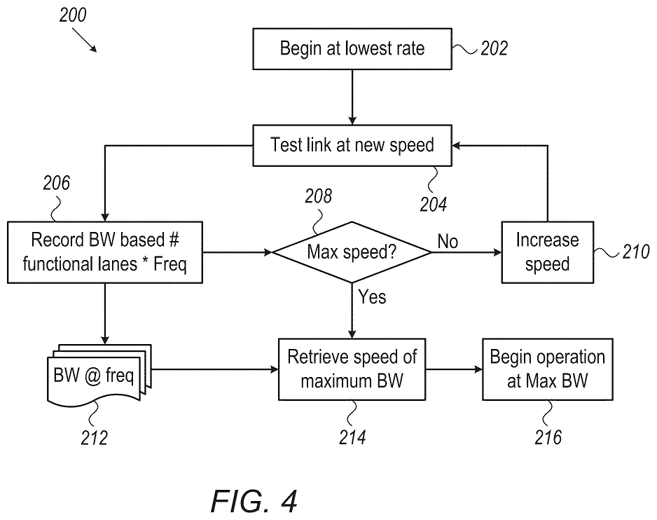

FIG. 4 is a flow chart that schematically illustrates a method 200 for compensating for bandwidth loss in electronic device 10 by obtaining a maximum bandwidth in the die-to-die interconnect, in accordance with an embodiment that is described herein. In some embodiments, method 200 is performed by processor 24 within PHY block 23 during a setup phase, as described in FIGS. 1 and 2 above.

At a start testing step 202, processor 24 initiates the maximum bandwidth determination process at the lowest rate. Die-to-die test block 44 begins testing lanes 22 at a base operating frequency.

At a link testing step 204, die-to-die test block 44 tests the link at the current operating frequency to determine the number of functional lanes at that frequency.

At a bandwidth recording step 206, processor 24 records the bandwidth based on the number of functional lanes 22 multiplied by the operating frequency. The bandwidth at each operating frequency is stored for later comparison.

At a decision step 208, processor 24 determines whether the maximum operating frequency has been reached. If the maximum operating frequency has not been reached (“No” branch), method 200 proceeds to a speed increasing step 210.

At speed increasing step 210, DVFS block 33 increases the operating frequency. Method 200 then loops back to link testing step 204 to test the link at the new operating frequency.

If the maximum operating frequency has been reached (“Yes” branch) at decision step 208, method 200 proceeds to a storage step 212, where processor 24 stores the bandwidth values recorded at each operating frequency.

At a retrieving step 214, processor 24 retrieves the operating frequency that obtained the maximum bandwidth from storage step 212.

At an operation step 216, after concluding the setup phase, PHY block 23 begins operation at the maximum bandwidth using the retrieved operating frequency during a mission mode.

Method 200 provides a systematic approach to determining the optimal operating frequency for PHY block 23 by sweeping through available frequencies from a base operating frequency to a maximum operating frequency, recording the achieved bandwidth at each frequency based on the number of functional lanes 22, and selecting the frequency that yields the highest aggregate bandwidth.

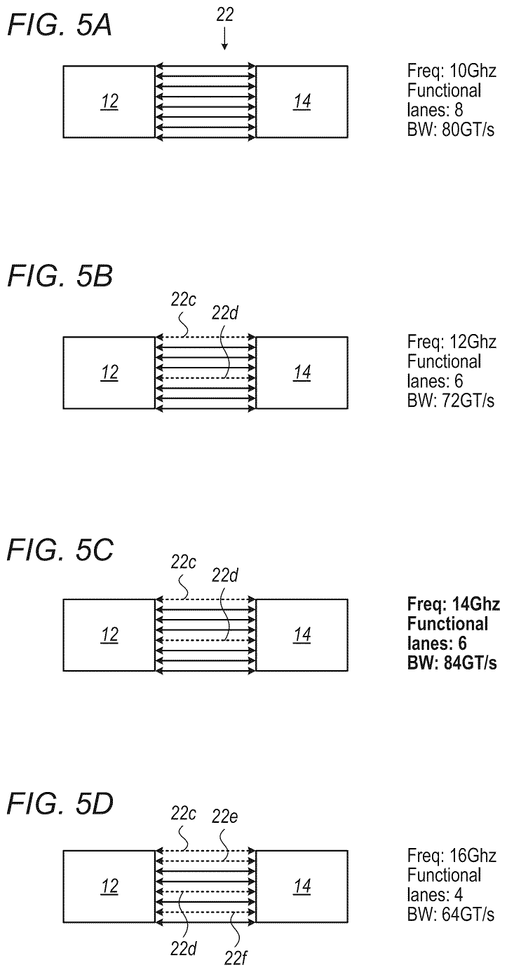

FIGS. 5A, 5B, 5C, and 5D are block diagrams that schematically illustrate examples of various operating conditions applied based on method 200 for compensating for bandwidth loss of FIG. 4, in accordance with embodiments that are described herein. The figures show first die 12 connected to second die 14 through lanes 22.

FIG. 5A depicts an initial configuration where all eight lanes 22 are functional. PHY block 23 operates at a frequency of 10 GHz with eight functional lanes 22, providing a total bandwidth of 80 GT/s. Processor 24 records this bandwidth value.

FIG. 5B illustrates a configuration where DVFS block 33 has increased the operating frequency to 12 GHz. At this higher frequency, two lanes become non-functional, shown as non-functional lane 22c and non-functional lane 22d, which are collectively part of non-functional lanes 22k. With six functional lanes operating at 12 GHz, the total bandwidth is 72 GT/s. Processor 24 records this bandwidth value.

FIG. 5C shows a further increase in frequency to 14 GHz. Non-functional lane 22c and non-functional lane 22d remain non-functional at this frequency. However, with six functional lanes 22 operating at 14 GHz, the total bandwidth increases to 84 GT/s, representing the maximum bandwidth achievable in this example. Processor 24 records this bandwidth value.

FIG. 5D depicts the configuration at the maximum frequency of 16 GHz. At this frequency, additional lanes fail, comprising non-functional lane 22e and non-functional lane 22f, in addition to the previously non-functional lane 22c and non-functional lane 22d. These non-functional lanes are collectively referred to as non-functional lanes 22k. With only four functional lanes remaining at 16 GHz, the total bandwidth drops to 64 GT/s.

The sequence of FIGS. 5A-5D demonstrates that the optimal operating point for maximizing bandwidth occurs at 14 GHz with six functional lanes, achieving 84 GT/s, rather than at the maximum frequency of 16 GHz where additional lane failures reduce the overall bandwidth. Processor 24 retrieves the 14 GHz operating frequency from storage and operates PHY block 23 at this frequency during mission mode.

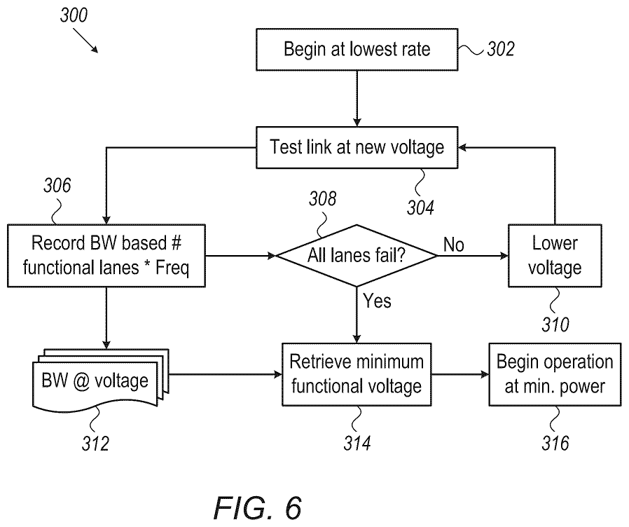

FIG. 6 is a flow chart that schematically illustrates a method 300 for compensating for bandwidth loss in electronic device 10 by obtaining maximum bandwidth at reduced power consumption, in accordance with an embodiment that is described herein. Method 300 is performed by processor 24 within PHY block 23 during a setup phase, as described in FIGS. 1 and 2 above.

At a start testing step 302, processor 24 initiates the minimum power determination process. Die-to-die test block 44 begins testing lanes 22 at a base operating voltage.

At a link testing step 304, die-to-die test block 44 tests the link at the current operating voltage and determines the number of functional lanes 22 at that voltage.

At a bandwidth recording step 306, processor 24 records the bandwidth based on the number of functional lanes 22 multiplied by the operating frequency. The bandwidth at each operating voltage is stored for later comparison.

At a decision step 308, processor 24 determines whether all lanes 22 have failed. If all lanes have not failed (“No” branch), method 300 proceeds to a voltage reducing step 310.

At voltage reducing step 310, DVFS block 33 lowers the operating voltage. Method 300 then loops back to link testing step 304 to test the link at the new operating voltage.

If all lanes have failed (“Yes” branch) at decision step 308, method 300 proceeds to a storage step 312, where processor 24 stores the bandwidth values recorded at each operating voltage.

At a retrieving step 314, processor 24 retrieves the minimum functional voltage that provides the desired bandwidth from storage step 312.

At an operation step 316, PHY block 23 begins operation at minimum power using the retrieved minimum functional voltage during a mission mode following the setup phase.

Method 300 provides a systematic approach to finding an optimal operating point that minimizes power consumption while maintaining the desired bandwidth. The method sweeps through available voltage levels from a base operating voltage to lower voltages, recording the achievable bandwidth at each level, and then selects the lowest voltage that still provides functional operation meeting the target bandwidth.

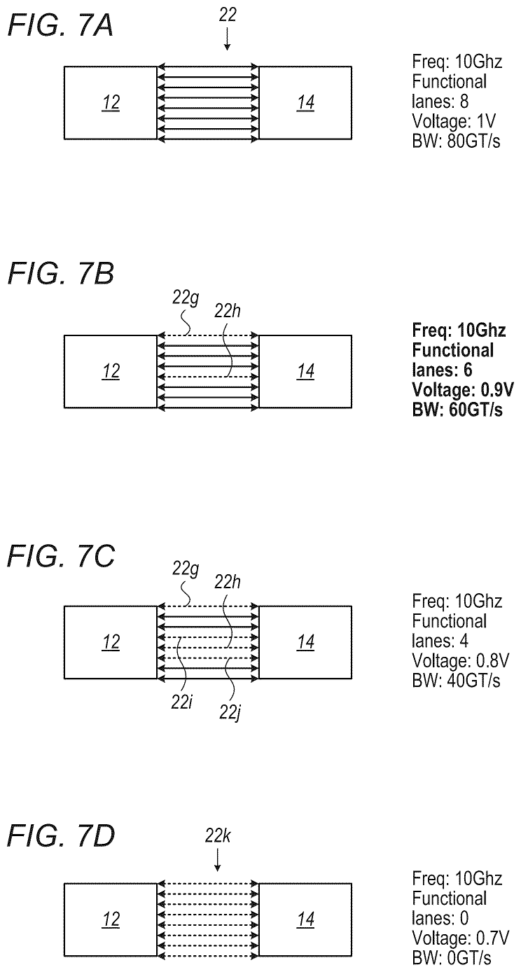

FIGS. 7A-7D are block diagrams that schematically illustrate various operating conditions applied based on method 300 for compensating for bandwidth loss of FIG. 6, in accordance with embodiments that are described herein. These figures show first die 12 connected to second die 14 through lanes 22, with a target bandwidth of 55 GT/s.

FIG. 7A shows the initial state where all eight lanes 22 between first die 12 and second die 14 are functional. PHY block 23 operates at a frequency of 10 GHz with a voltage of 1V, providing a bandwidth of 80 GT/s. Processor 24 records this bandwidth value.

FIG. 7B illustrates a state where DVFS block 33 has reduced the voltage to 0.9V while maintaining the frequency at 10 GHz. At this reduced voltage, two lanes become non-functional, identified as non-functional lane 22g and non-functional lane 22h. With six functional lanes 22 remaining, as such PHY block 23 provides a bandwidth of 60 GT/s, which exceeds the target bandwidth of 55 GT/s. Processor 24 records this bandwidth value.

FIG. 7C depicts a further reduction in voltage to 0.8V. At this voltage level, two additional lanes fail, identified as non-functional lane 22i and non-functional lane 22j, in addition to the previously failed non-functional lane 22g and non-functional lane 22h. With only four functional lanes remaining, PHY block 23 provides a bandwidth of 40 GT/s, which falls below the target bandwidth of 55 GT/s.

FIG. 7D shows the state when DVFS block 33 reduces the voltage to 0.7V. At this voltage, all lanes become non-functional lanes 22k, resulting in zero functional lanes and a bandwidth of 0 GT/s.

The progression from FIG. 7A through FIG. 7D demonstrates a voltage sweep procedure where processor 24 tests progressively lower voltages to identify the minimum voltage that still meets the target bandwidth requirement. In this example, the configuration shown in FIG. 7B with a voltage of 0.9V and six functional lanes providing 60 GT/s represents the lowest power operating point that exceeds the target bandwidth of 55 GT/s. Processor 24 retrieves the 0.9V operating voltage from storage and operates PHY block 23 at this voltage during mission mode to minimize power consumption while meeting the bandwidth requirement.

These particular examples of operating conditions of FIGS. 2-7D are shown by way of example, in order to illustrate certain problems that are addressed by embodiments of the present invention and to demonstrate the application of these embodiments in enhancing the performance of such PHY blocks 23 and electronic device 10. Embodiments of the present invention, however, are by no means limited to this specific sort of example PHY blocks and electronic device, and the principles described herein may similarly be applied to other sorts of PHY blocks and/or electronic devices.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A physical-layer interface (PHY) between a first die and a second die, the PHY comprising:
a plurality of lanes configured to transfer signals between the first die and the second die; and
a processor, which is configured to:
detect a non-functional lane among the plurality of lanes; and
adjust one or more electrical parameters of one or more functional lanes among the plurality of lanes to compensate for bandwidth loss caused by the non-functional lane.

2. The PHY according to claim 1, wherein the one or more electrical parameters comprise an operating frequency and an operating voltage, and wherein the processor comprises a dynamic voltage and frequency scaling (DVFS) block, which is configured to adjust at least one of the operating frequency and the operating voltage of the one or more functional lanes.

3. The PHY according to claim 2, wherein the processor comprises a die-to-die test block, which is configured to test the plurality of lanes and detect the non-functional lane.

4. The PHY according to claim 2, wherein the processor is configured to determine whether a target bandwidth is achieved in response to adjusting at least one of the operating frequency and the operating voltage.

5. The PHY according to claim 4, wherein the processor is configured to further adjust at least one of the operating frequency and the operating voltage to achieve the target bandwidth at a reduced operating voltage.

6. The PHY according to claim 4, wherein in response to not achieving the target bandwidth, the processor is configured to negotiate a revised bandwidth less than the target bandwidth based on the (i) non-functional lane, and (ii) adjusted at least one of the operating frequency and the operating voltage of the one or more functional lanes.

7. The PHY according to claim 1, wherein, in response to adjusting the one or more electrical parameters, the processor is configured to detect an additional non-functional lane among the one or more functional lanes.

8. The PHY according to claim 7, wherein, in response to detecting the additional non-functional lane, the processor is configured to iteratively adjust the one or more electrical parameters of one or more remaining functional lanes to compensate for bandwidth loss caused by the non-functional lane and the additional non-functional lane.

9. The PHY according to claim 1, wherein, in response to adjusting the one or more electrical parameters, the processor is configured to redetermine the functionality of the detected non-functional lane.

10. The PHY according to claim 1, wherein the processor comprises an interface configured to present a consistent bandwidth between the first die and the second die regardless of the non-functional lane.

11. A method for compensating for bandwidth loss in a physical-layer interface (PHY) between a first die and a second die, the method comprising:
during a setup phase, testing a plurality of lanes configured to transfer signals between the first die and the second die;
detecting a non-functional lane among the plurality of lanes; and
adjusting one or more electrical parameters of one or more functional lanes among the plurality of lanes to compensate for bandwidth loss caused by the non-functional lane.

12. The method according to claim 11, wherein the one or more electrical parameters comprise an operating frequency and an operating voltage.

13. The method according to claim 12, wherein adjusting the one or more electrical parameters comprises increasing at least one of the operating frequency and the operating voltage of the one or more functional lanes.

14. The method according to claim 11, further comprising determining whether a target bandwidth is achieved in response to adjusting the one or more electrical parameters.

15. The method according to claim 14, further comprising, in response to not achieving the target bandwidth, iteratively adjusting the one or more electrical parameters until the target bandwidth is achieved or a maximum operating frequency is reached.

16. The method according to claim 11, further comprising:
testing the plurality of lanes at a plurality of combinations of operating frequencies and operating voltages;
recording, for each combination, a bandwidth based on a number of functional lanes at the combination;
storing the combination of operating frequency and operating voltage that obtained a maximum bandwidth; and
operating the PHY at the stored combination during a mission mode following the setup phase.

17. The method according to claim 16, wherein testing the plurality of lanes at the plurality of combinations comprises sweeping from a base operating frequency to a maximum operating frequency and from a base operating voltage to a maximum operating voltage.

18. The method according to claim 11, further comprising, in response to adjusting the one or more electrical parameters, detecting an additional non-functional lane among the one or more functional lanes, and iteratively adjusting the one or more electrical parameters of one or more remaining functional lanes to compensate for bandwidth loss caused by the non-functional lane and the additional non-functional lane.

19. The method according to claim 11, further comprising, in response to adjusting the one or more electrical parameters, redetermining the functionality of the detected non-functional lane.

20. The method according to claim 11, wherein the setup phase comprises at least one of a boot sequence and a link training phase.
